(19) United States
(12) Patent Application Publication
(10) Pub. No.: US 2013/0105037 A1
(43) Pub. Date: May 2, 2013

(54) FILLING OUTLET, ITS USE AND FILLING METHOD

(71) Applicants: Antoine Frenal, Ezanville (FR); Philippe Deck, Montreuil (FR); Cyril Manscourt, Vanves (FR); Philippe Pisot, Apprieu (FR)

(72) Inventors: Antoine Frenal, Ezanville (FR); Philippe Deck, Montreuil (FR); Cyril Manscourt, Vanves (FR); Philippe Pisot, Apprieu (FR)

(73) Assignee: L'Air Liquide, Société Anonyme pour I'Etude et I'Exploitation des Procédés Georges Claude, Paris (FR)

(21) Appl. No.: 13/808,519

(22) PCT Filed: May 19, 2011
(86) PCT No.: PCT/FR2011/051132

§ 371 Date: Jan. 4, 2013

(30) Foreign Application Priority Data
Jul. 9, 2010 (FR) 1055606

(51) Int. Cl. B67C 3/26

(52) U.S. Cl. CPC B67C 3/26
USPC 141/1; 141/386

(57) ABSTRACT

Filling outlet comprising at least one claw (2) extending in a longitudinal direction about a longitudinal axis (A), the central space situated between the claw or claws (2) and the longitudinal axis (A) forming a housing intended to accommodate a filling connector (1) of cylindrical overall shape, characterized in that the internal face of the at least one claw (2) situated facing the central space is of flat overall shape and has reliefs (12) and/or recesses (22) of set dimensions, the reliefs (12) and/or recesses being spaced relative to one another in a set fashion so that they fit into mating grooves (11) and/or reliefs (21) formed on the exterior face of a filling connector (1), the at least one claw (2) being able to move transversely with respect to the longitudinal axis (A) between a position called the “open” position to allow a connector (1) to be introduced into the central space, and a position called the “closed” position to allow the internal face of the claws (2) to engage on the exterior face of a connector (1), the said outlet comprising a locking member (3) able to move between an active position that locks the claws (2) in the closed position and an inactive position that allows the claws (2) to move into the open position.

### CROSS REFERENCE TO RELATED APPLICATIONS

This application is a 371 of International PCT Application PCT/FR2011/051132, filed May 19, 2011, which claims priority to French Application 1055606 filed Jul. 9, 2010, the entire contents of which are incorporated herein by reference.

### BACKGROUND

The present invention relates to a pressurized-gas filling nozzle, a unit comprising a connector and a filling nozzle, the use thereof and a corresponding filling method.

More specifically, the invention concerns a filling nozzle designed to engage with a filling connector of a faucet of a pressurized-fluid recipient, including at least one claw extending longitudinally about a longitudinal axis, the central space located between the claw or claws and the longitudinal axis forming an enclosure intended to receive a filling connector of cylindrical overall shape.

### SUMMARY

The invention concerns in particular the filling of high-pressure gas bottles (for example between 200 and 700 bar).

The present invention concerns in particular a mechanism for quickly connecting a filling nozzle (or clamp) to a connector of a gas bottle to enable said bottle to be filled.

Such devices usually have two functions:
A locking function (i.e. mechanical engagement) of the nozzle to the connector and
A fool-proofing system (i.e. a male/female system that only allows a specific nozzle to be connected to a specific type of connector to prevent dangerous connections).

To ensure the “fool proofing” function, most manufacturers use lugs on the profile of the filling connector.

However, these connection systems make connection operations more difficult, in particular automatic connection operations.

According to another known system, a jaw system of a filling nozzle engages the threads of a threaded connector to enable the unit to be locked. The drawback of such a system relates essentially to safety, since the operator is not able to properly check the quality of the lock. Furthermore, the threads of the threaded connector tend to become damaged, which affects the quality of the mechanical connection.

Document FR2570469 describes a filling nozzle comprising articulated pegs that selectively grip the body of the faucet such as to sealingly hold a gas inlet of the nozzle against the gas inlet of the faucet.

This type of engagement and seal is however difficult to implement by operators and does not provide a sufficient guarantee of safety, in particular for filling at industrial rates. The positioning of the filling nozzle in relation to the faucet is also difficult and hard to automate.

Documents U.S. Pat. No. 6,343,630 and DE 92 176 29 describe systems for delivering high-pressure fluid including engagement jaws that are longitudinally movable in relation to a fixed external sleeve.

The jaws and an internal piston can be moved longitudinally under the action of a connection incorporated into the delivery system.

Document EP 1 447 574 A1 describes a system for the mechanical connection of two shafts.

One objective of this invention is to mitigate some or all of the drawbacks of the prior art as set out above.

For this purpose, the filling nozzle according to the invention, which conforms to the generic definition given in the preamble above, is essentially characterized in that the internal face of the at least one claw located facing the central space is of flat overall shape and has reliefs and/or recesses of set dimensions, the reliefs and/or recesses being spaced relative to one another in a set fashion so that they fit into the matching grooves and/or reliefs formed on the external face of a filling connector, the at least one claw being movable transversely in relation to the longitudinal axis between an “open” position to enable the insertion of a connector in the central space and a “closed” position to enable the internal face of the claws to fit the external face of a connector, said nozzle including a locking member movable between an active position locking the claws in closed position and an inactive position enabling the claws to move to the open position.

Using a simple and cheap mechanism, the invention performs the following functions:
Engagement to ensure a good locking of a filling nozzle to a connector and
Fool-proofing, to ensure that the filling nozzle fits the connector it is combined with (or vice versa).

Moreover, the embodiments of the invention may have one or more of the following features:
The nozzle includes several claws spaced out from each other about the longitudinal axis,
The nozzle includes at least one claw that can be moved between the open and closed positions by means of a pivoting movement about an axis of articulation,
The locking member includes a sleeve of tubular overall shape arranged about the at least one claw,
The sleeve is movable in translation in a direction parallel to the longitudinal axis,
The locking member is pushed by default towards the active position thereof by a return member.
When the at least one claw is in open position, a stop prevents the locking member from moving from the inactive position to the active position, and in that, when the at least one claw is in closed position, the movement of the locking member from the inactive position to the active position is not prevented by the stop,
The nozzle includes a movable member for selectively opening the claws, said opening member being movable between a “working” position preventing movement of the claws from the open position to the closed position and an “idle” position enabling the movement of the claws from the open position to the closed position,
The opening member is pushed by default towards the working position thereof by a return member,
The opening member opens into the central space located between the at least one claw and the longitudinal axis, the opening member being movable from the working position thereof to the idle position thereof under the direct or indirect mechanical action of the filling connector when this latter penetrates the central space of the filling nozzle,
The nozzle includes a valve actuator that is selectively movable in the central space to actuate the opening of at least one internal valve of a filling connector.
The claws are movable in translation between the open and closed positions,
The nozzle includes at least one claw movable between the open and closed positions via a bending and/or pivoting movement about an axis of articulation fixed in relation to the base located on an “upstream” extremity of the claw, i.e. the axis of articulation is located at an extremity of the claw that is on the upstream side of the nozzle in the direction of flow of the filling gas in the nozzle,
The filling nozzle includes three or four claws arranged about the longitudinal axis,
The stop selectively preventing the passage of the locking member from the inactive position to the active position includes at least one shoulder formed on at least one claw,
The opening member includes a surface forming a selective stop preventing the approach of the at least one claw as a function of the position of the opening member in relation to the at least one claw,
The opening member includes a body of tubular overall shape, the external surface of which has a sloping profile intended to accept and guide the at least one claw, to determine the opening of said at least one claw in relation to the longitudinal axis,
The opening member is movable in translation in a direction parallel to the longitudinal axis,
The valve actuator of the filling nozzle is movable in translation independently of the position of the at least one claw and of the position of the locking member,
The return member pushing the opening member includes at least either: a compression spring or a traction spring,
The nozzle includes a movable part that is sensitive to the internal pressure in the filling nozzle, to selectively lock the locking member in the active position when the filling nozzle is under pressure, i.e. when the nozzle is distributing the pressurized fluid,
The connector is oriented vertically, i.e. the filling nozzle is mechanically connected vertically from top to bottom to said connector.

The invention also concerns a unit comprising a filling connector and a filling nozzle, the filling nozzle having any one of the features set out above or below, the filling connector comprising a body of cylindrical overall shape extending along a longitudinal axis, the external surface of which has transversal grooves and/or reliefs of set dimensions oriented perpendicular to the longitudinal axis of the connector, the grooves and/or reliefs being spaced in a set manner in the longitudinal direction of the connector, the reliefs and/or recesses of the at least one claw matching said grooves and/or reliefs of the connector to enable a selective engagement of the claws to the body of the connector.

According to other possible features:
At least some of the transversal grooves and/or reliefs are formed on the circumference of the body of the connector to enable an engagement of the at least one claw to the body of the connector regardless of the angular position of the at least one claw about the longitudinal axis of the connector,

Thus, the fool-proofing function (i.e. the correct geometric match between the filling nozzle and the connector) needs no angular indexing of one part in relation about the longitudinal axis. This facilitates the connection, in particular a potential automatic connection of the nozzle to the connector.

According to other possible features:
The filling nozzle connects mechanically via the claw or claws only to a filling connector with no mechanical attachment to the body of a faucet bearing the connector,
The filling connector includes a body forming an internal filling circuit between one upstream extremity connecting to the filling nozzle and one downstream extremity linking a recipient, the connector comprising an isolating valve movable in relation to a seat between an upstream closed position of the circuit and a downstream open position of the circuit, said isolating valve being pushed towards the upstream position thereof by a return member, the connector also including a dust valve arranged upstream of the isolating valve, said dust valve being movable in relation to the body between an upstream closed position of the upstream extremity of the circuit and a downstream open position of the upstream circuit extremity, said dust valve being pushed towards the upstream position thereof by a return member,
The dust valve has a filter interposed on the route of at least some of the fluid passing between the upstream extremity and the downstream extremity of the circuit, the filter being movable with the dust valve,
The dust valve includes a downstream extremity and, when said dust valve is in a given “contact” downstream position opening the upstream extremity of the circuit, this downstream extremity of the dust valve pushes an upstream extremity of the movable isolating valve to move the isolating valve towards the downstream open-circuit position thereof.

The invention also relates to a use of a filling nozzle according to any one of the features set out above or below or a unit according to any one of the features set out above or below for filling a pressurized fluid recipient, in particular a pressurized gas bottle.

The invention also concerns a method for filling a recipient with pressurized fluid, said recipient having a faucet with a filling connector provided with a body of cylindrical overall shape extending along a longitudinal axis, the external surface of which includes transversal grooves and/or reliefs of set dimensions oriented perpendicular to the longitudinal axis of the connector, the connector including at least one internal valve, the method comprising a step in which the connector is mechanically connected to a filling nozzle according to any one of the features set out above or below, the internal face of the at least one claw of the filling nozzle matching the external shape of the connector.

According to other possible features:
The filling method involves a step in which the locking member is locked in the active position when the filling nozzle is under pressure and/or when at least one valve of the filling connector is open,
The method includes a step in which the at least one valve of the filling connector is opened selectively, the step in which the at least one valve is opened selectively is performed independently of the step in which the filling nozzle is connected mechanically to the connector, in particular the step in which the at least one valve is opened is performed after the step in which the filling nozzle is connected mechanically to the connector.

The invention may also relate to any alternative device or method comprising any combination of the features set out above and below.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a partial perspective view showing a detail of a filling nozzle connecting to a connector according to a possible example embodiment of the invention,

FIGS. 2 and 3 are partial longitudinal cross sections showing two successive states in the process of engaging a filling nozzle to a connector according to a possible example embodiment of the invention,

FIG. 4 is a cross section showing a filling nozzle according to a possible example embodiment of the invention,

FIG. 5 shows the filling nozzle from FIG. 4 connected to a filling connector in which the filling nozzle begins a process for opening the internal valves of the filling connector,

FIG. 6 is a schematic view of the filling nozzle from FIG. 5 mounted on a recipient and in which the filling nozzle opens two internal valves of the filling connector.

### DESCRIPTION OF PREFERRED EMBODIMENTS

The filling nozzle shown in FIG. 1 includes three claws 2 extending in a longitudinal direction about a longitudinal axis A. The claws 2 delimit a central space located about the longitudinal axis A forming an enclosure intended to receive a filling connector 1 of cylindrical overall shape (see FIG. 1).

In the example described, the filling nozzle includes three claws 2 arranged about the axis 2 but, naturally, a nozzle having one, two or more than three claws 2 would be possible.

The claws 2 are for example arranged symmetrically about the axis A (at 120° from each other).

The internal face of the claws 2 (i.e. the face of the claws 2 turned towards the central space and the axis A) is preferably flat and includes reliefs 12 and recesses 22 of set dimensions (dimensions determined transversely and perpendicularly to the axis A).

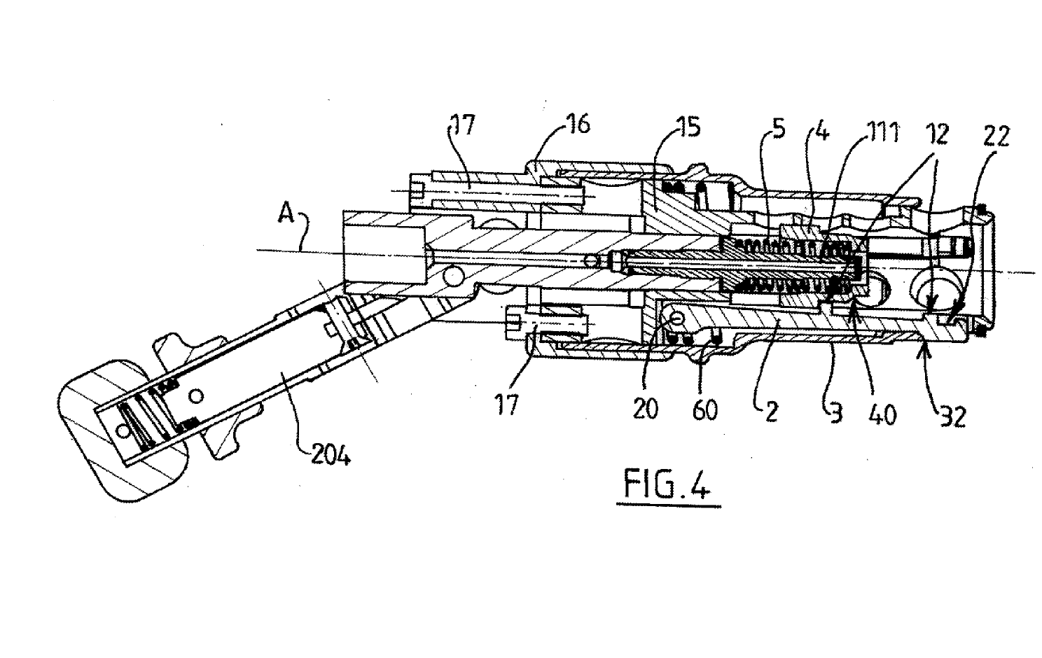

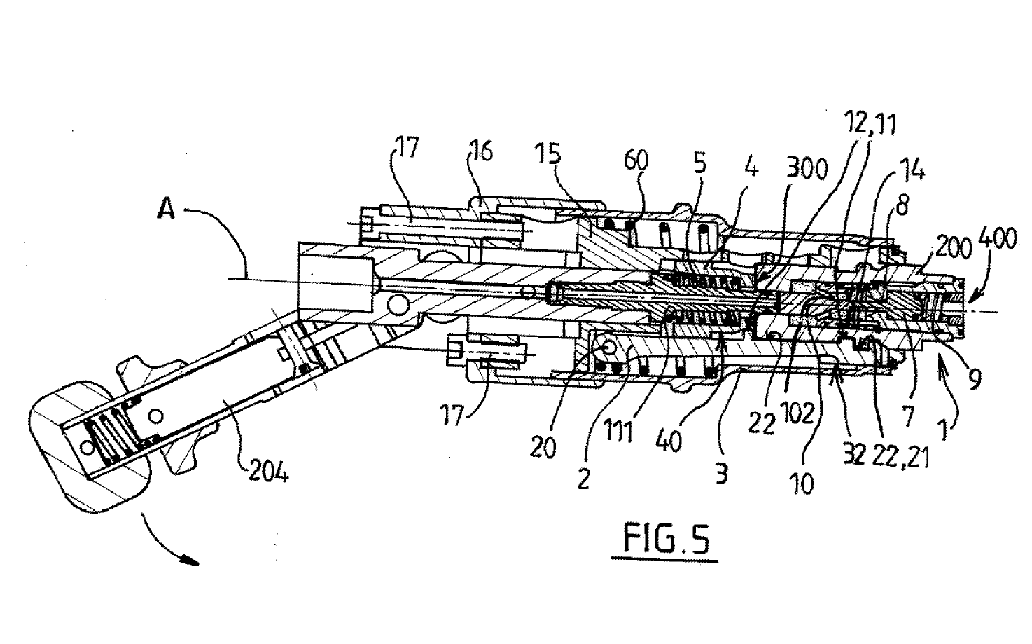

Furthermore, the reliefs 12 and recesses 22 are spaced longitudinally in relation to one another in a set manner to fit into the matching grooves 11 and reliefs 21 located on the external face of a filling connector 1 (see FIG. 1 and FIG. 4), i.e. the reliefs 12 and recesses 22 have set locations in a direction parallel to the axis A when the claws are parallel to this axis A.

Thus, the nozzle fits a given connector geometry, limiting the connection to a specific type of connector, to enable the mechanical connection for compatible applications only (to ensure for example compatibility of the gas type and filling pressure).

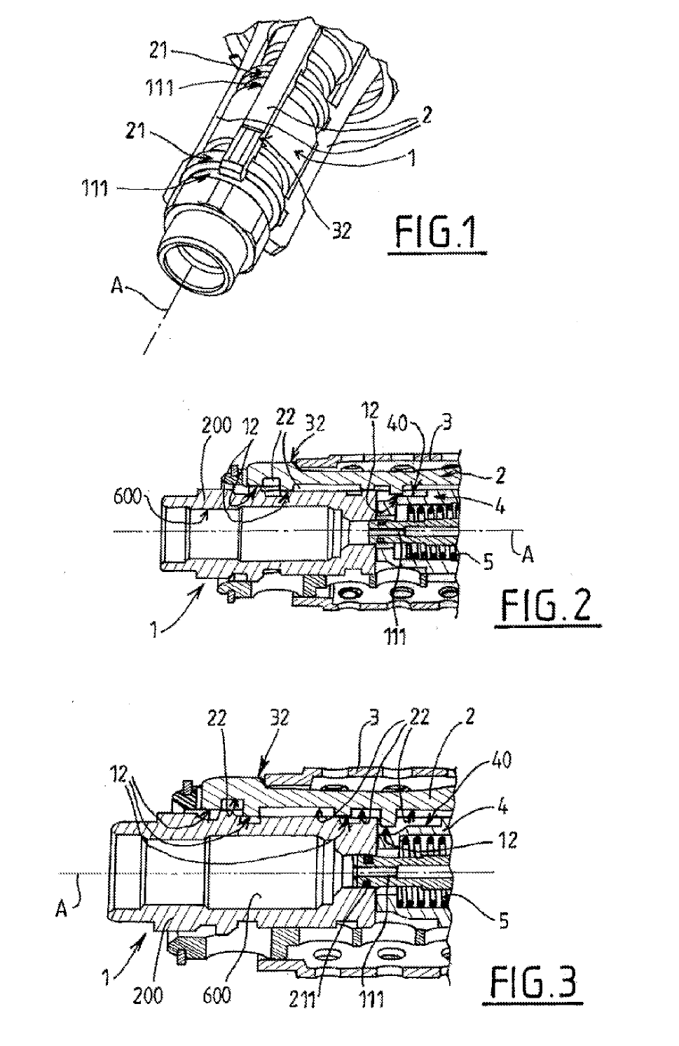

At least one and preferably all of the claws 2 are movable transversely in relation to the longitudinal axis A between an “open” position to enable the insertion of a connector 1 in the central space (see FIG. 2) and a “closed” position to enable the internal face of the claws 2 to fit the external face of a connector 1 (see FIG. 5).

For example, the claw or claws 2 can be moved between the open and closed positions by means of a pivoting movement about an axis 20 of articulation. As shown in FIG. 1, the axis of articulation of the claws 2 is located at an “upstream” extremity of the claw 2, i.e. at an extremity of the claw 2 located on the upstream side of the nozzle in the direction of flow of the filling gas in the nozzle upstream to downstream (when the nozzle is supplying a filling connector).

Naturally, the movement of the claws 2 between the open and closed positions by means of a bending and/or a translational movement of the claws 2 would be possible as a variant or combination.

The nozzle also includes a locking member 3 that is movable between an active position locking the claws 2 in closed position and an inactive position enabling the movement of the claws 2 to the open position.

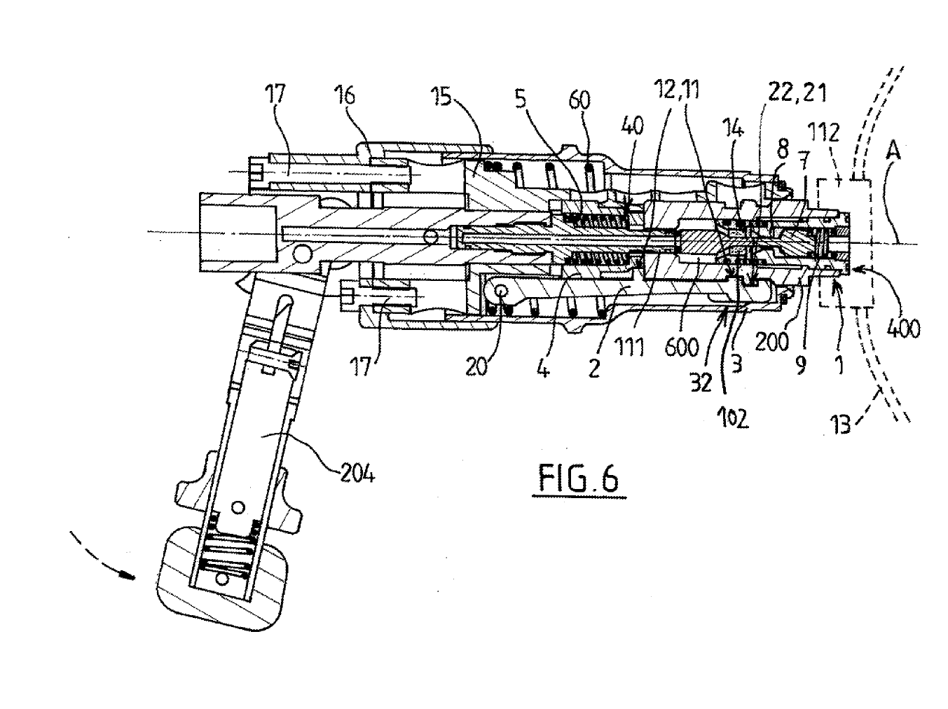

As shown, the locking member 3 may include a sleeve 3 of tubular overall shape arranged about the claws 2. The sleeve 3 is selectively movable in translation in relation to the claws 2 in a direction parallel to the longitudinal axis A between the inactive position (upstream, see FIGS. 2, 3 and 4) and the active position (downstream, see FIGS. 5 and 6).

As shown in FIGS. 4 and 5, the upstream extremity of the sleeve 3 may be mounted slidingly between a lower base 15 and an external casing 16. For example, the base 15 is mounted on the casing 16 by means of one or more attachment members such as screws 17. The base 15 is for example of tubular overall shape and houses a valve actuator 111, which is preferably mobile.

In active position (towards the downstream extremity) the sleeve 3 grips the claws 2 in closed position, i.e. in downstream position, the sleeve 3 forms a mechanical stop preventing the claws 2 from opening. In inactive position (towards the upstream extremity of the nozzle, see FIGS. 2, 3 and 4), the sleeve 3 enables the claws 2 to move into the open position.

For example, the downstream extremity of the external face of the claws 2 includes a shoulder forming a stop 32 intended to engage the sleeve to define the active and inactive positions of the sleeve 3. Furthermore, these stops 32 can selectively prevent or enable movement of the sleeve 3 from the inactive position to the active position. In the closed position of the claws 2, the movement of the sleeve 3 from the inactive position to the active position (sliding in the downstream direction) is not prevented by the stop 32.

The sleeve 3 is preferably pushed by default towards the active position thereof (towards the downstream extremity) by a return member 60 such as a compression spring.

For example, the upstream extremity of the spring 60 bears against the base 15.

The nozzle may also preferably include a movable member 4 for selectively opening the claws 2. This opening member 4 has for example a tubular shape and is mounted in the base 15, about the movable valve actuator 111. The opening member 4 is preferably movable in translation along the longitudinal axis A. This opening member 4 is movable between a “working” position preventing movement of the claws 2 from the open position to the closed position and an “idle” position enabling the movement of the claws 2 from the open position to the closed position.

The opening member 4 includes an external surface forming a selective stop preventing or permitting the approach of the claws 2 as a function of the longitudinal position of the opening member 4 in relation to the claws 2.

For example, as shown in FIGS. 2 to 5, the opening member 4 includes a body of tubular overall shape, the external surface of which has a sloping profile 40 that guides at least one claw 2. For example a relief 12 of the internal face of at least one claw 2 is guided by contact with the sloping profile 40. The sloping profile 40 therefore causes the at least one claw 2 to open in relation to the longitudinal axis A.

The opening member 4 is preferably pushed by default towards the working position thereof (downstream) by a return member 5 such as a compression spring. The spring 5 of the opening member 4 is for example mounted about the valve actuator 111 and bears against this latter.

An example connection of such a filling nozzle to a filling connector 1 is described below.

FIG. 4 shows a filling nozzle in disconnected position. The claws 2 are in relatively open position. The locking sleeve 3 is locked by the claws 2 in inactive position (upstream). The opening member 4 is in working position (upstream).

When the filling nozzle is placed on the filling connector 1 along the longitudinal axis (from right to left in FIG. 2), the claws 2 open out if necessary to enable the insertion of the connector 1 into the central space of the filling nozzle. The extremity of the connector 1 is then in contact with the extremity of the opening member 4. The extremity of the connector 1 then pushes the opening member 4 towards the upstream extremity of the filling nozzle against the force of the spring 5. The retreating movement (towards the upstream extremity of the nozzle) of the opening member 4 enables the claws 2 to approach the longitudinal axis A (via the sloping profile 40). The reliefs 12 and recesses 22 of the claws 2 engage with the recesses 11 and reliefs 21 of the external surface of the connector 1 (see FIG. 3 then FIG. 5).

The claws 2 pivot and close onto the connector 1. This engagement is only possible if there is a good geometric fit between the claws 2 and the external profile of the connector 1.

Preferably, the transversal grooves 11 and/or reliefs 21 are formed about the entire circumference of the body of the connector 1. Thus, the claws 2 can engage with the body of the connector 1 regardless of the angular position of the claws 2 (and of the filling nozzle) about the longitudinal axis of the connector 1.

The approach of the claws 2 enables the sleeve 3 to slide (by means of the spring 60 thereof) automatically downstream above the claws (see FIG. 5) to prevent the claws 2 from opening.

Thus, unlocking is prevented and the nozzle remains engaged with the connector 1. To disconnect, the sleeve 3 must first be moved into inactive position (towards the upstream extremity) to enable the claws 2 to open. This movement of the sleeve into inactive position is done manually and/or automatically. Preferably, the filling nozzle may include an additional safety system (not shown) that makes it possible to prevent unlocking (movement of the sleeve 3 upstream) when the nozzle is under pressure (i.e. when it is supplying gas).

When the mechanical engagement is effected (see FIG. 5), the filling nozzle may command the valve(s) inside the connector 1 to open to supply the pressurized gas.

Preferably, the (mechanical) engagement of the nozzle to the connector 1 is independent of the opening of the valves of the connector and of the passage of the gas.

For example, the filling nozzle includes a valve actuator 111 that is movable in translation by electromechanical and/or hydraulic and/or pneumatic means and/or by means of a manual or automatic control lever 204.

The lever 204 is for example pivoting and transforms for example a rotational movement into a selective movement of the valve actuator 111 along the longitudinal axis A (see FIGS. 5 and 6).

As shown in a non-limiting manner, the valve actuator 111 may be tubular (the pressurized filling gas passing through the internal channel thereof). The downstream extremity of the valve actuator 111 may include a sealing system to sealingly connect it in the orifice of the filling connector 1 (i.e. inside the connector).

In a preferred but non-limiting embodiment shown in FIGS. 5 and 6, the filling connector 1 includes a body 200 forming an internal filling circuit 600 between an upstream extremity 300 connecting to the filling nozzle and a downstream extremity 400 linking a recipient 13 (see FIG. 6). The connector 1 is preferably mounted on a faucet 112 with or without a relief valve.

The connector 1 includes an isolating valve 7 that is movable in relation to a seat 8 between an upstream closed position of the circuit and a downstream open position of the circuit. The isolating valve 7 is pushed by default towards the upstream position thereof by a return member 9 such as a compression spring.

The connector 1 also includes a dust valve 10 placed upstream of the isolating valve 7. The dust valve 10 is movable in relation to the body 2 between an upstream closed position of the upstream extremity 3 of the circuit 6 and the downstream open position of the upstream circuit extremity 3.

The dust valve 10 is pushed towards the upstream position thereof by a return member 14 such as a compression spring.

Preferably, without being limitative, the dust valve 10 may include a filter 102 interposed on the route of at least some of the fluid passing between the upstream extremity 3 and the downstream extremity 4 of the circuit 6, the filter 102 being movable with the dust valve 10.

The filter (or filters where applicable) have for example a metal or other structure to retain solid particles, for example larger than 0.05 mm or larger than 0.1 mm or larger than 1 mm or larger than 2 mm (as required).

According to an advantageous feature, the dust valve 10 includes a downstream extremity and, when said dust valve 10 is in a given “contact” downstream position opening the upstream extremity 3 of the circuit 6, this downstream extremity of the dust valve 10 pushes an upstream extremity of the movable isolating valve 7 to move the isolating valve 7 towards the downstream open-circuit position thereof.

As shown, the dust valve 10 (and the filter 102 thereof) may be moved towards the downstream extremity by mechanical contact of the valve actuator 111 (alternatively, pressurized gas coming from the filling nozzle can move the valve 10 towards the downstream extremity).

Thus, the upstream dust valve 10 can act as an actuator for the downstream isolating valve 7, i.e. the dust valve 10 can indirectly transmit the force generated by the filling nozzle to the downstream isolating valve 7. Naturally, alternatively this downstream isolating valve 7 may also be moved by the pressure of gas delivered by the filling nozzle.

Alternatively, the isolating valve 7 may include a non-return valve preventing the isolating valve 7 from opening except through mechanical contact (by means of the dust valve 10).

As shown above, while having a simple structure, the invention proposes a highly safe system for connecting a filling nozzle to the connector thereof.

The system for geometrically matching the filling nozzle and the connector (the groove(s) and relief(s) of the connector and the claws 2 of the nozzle) make it possible to prevent the filling nozzle from being erroneously connected to a connector of a recipient unsuitable for the filling nozzle (unsuitable filling conditions or fluid).

This exclusive connection system covers a plurality of geometric filling-nozzle/connector pairings that are similar but different.

For example, by providing two grooves 11 and two reliefs 21 on the connector 1 in different longitudinally offset positions, it is possible to provide a plurality of different contact areas (for example more than thirty).

This system also makes it possible to increase safety when filling the corresponding bottles (for example by preventing a bottle containing oxidant from being connected to a filling nozzle supplying fuel).

The structure according to the invention also makes it possible to implement filling procedures that are particularly efficient in terms of safety for operators in charge of the filling and end users of the faucet and of the gas bottle fitted with such a connector.

Thus, for example, with reference to FIG. 5, the movable dust valve 10 can adopt, during movement thereof, at least two sealed positions enabling filling to be secured.

In a first sealed position, the dust valve 10 is moved towards the downstream extremity and opens the upstream inlet 300 of the connector without the isolating valve 7 being open (see FIG. 5). In this position, with the upstream valve 10 open and the downstream valve 7 closed, the chamber located upstream of the isolating valve 7 can be vacuumized (predetermined low pressure) for example using a filling tool to perform pre-filling tests. In this arrangement, it is in effect possible to measure any leaks coming from the isolating valve 7.

In another sealed position (see FIG. 6), the isolating valve 7 can also be opened to perform a fill and/or to purge the circuit of the connector and of the bottle before filling.

On completion of the fill, the isolating valve 7 can be re-closed and the dust valve 10 can be kept open (see FIG. 5) to perform any necessary post-filling seal tests, such as the pre-filling tests described above.

Whether or not there is a movable filter on a dust valve 10 (the filter may be omitted), the filling method according to the invention thus helps to improve filling safety by means of the use of the double serial valve mechanism described above.

The filling connector may also be the gas extraction connector, where necessary.

The mechanism described above in particular enables filling to be automated, in particular if the connection does not require angular indexing between the filling connector and the filling nozzle.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A filling nozzle designed to engage with a filling connector (1) of a faucet of a pressurized-fluid recipient, including a base (15, 16) and at least one claw (2) extending longitudinally about a longitudinal axis (A), the central space located between the claw or claws (2) and the longitudinal axis (A) forming an enclosure intended to receive a filling connector (1) of cylindrical overall shape, the internal face of the at least one claw (2) located facing the central space being of flat overall shape and having reliefs (12) and/or recesses (22) of set dimensions, the reliefs (12) and/or recesses (22) being spaced relative to one another in a set fashion so that they fit into the matching grooves (11) and/or reliefs (21) formed on the external face of a filling connector (1), the at least one claw (2) being movable in relation to the base (15, 16) transversely in relation to the longitudinal axis (A) between an open position to enable the insertion of the filling connector (1) in the central space and a closed position to enable the internal face of the claws (2) to fit the external face of the filling connector (1), said nozzle further including a locking member (3) movable in relation to the base (15, 16) and in relation to the at least one claw (2) between an active position locking the claws (2) in closed position and an inactive position enabling the claws (2) to move to the open position, the filling nozzle further characterized in that the locking member (3) is adapted to be pushed by default towards the active position thereof by a return member (60), and in that the filling nozzle includes a valve actuator (111) that is selectively movable in the central space to actuate the opening of at least one internal valve of a filling connector (1), the valve actuator (111) of the filling nozzle being movable in translation independently of the position of the at least one claw (2) and of the position of the locking member (3).

17. The filling nozzle as claimed in claim 16, comprising several claws (2) spaced apart from one another about the longitudinal axis (A).

18. The filling nozzle as claimed in claim 16, wherein at least one claw (2) is capable of movement between the open and closed positions by a pivoting movement about an axis (20) of articulation.

19. The filling nozzle according to claim 16, wherein the locking member includes a sleeve (3) of tubular shape arranged about the at least one claw (2).

20. The filling nozzle as claimed in claim 19, wherein the sleeve (3) is movable in translation in a direction parallel to the longitudinal axis (A).

21. The filling nozzle according to claim 16, wherein, when the at least one claw (2) is in the open position, a stop (32) prevents the locking member (3) from moving from the inactive position to the active position, and in that, when the at least one claw (2) is in closed position, the movement of the locking member (3) from the inactive position to the active position is not prevented by the stop (32).

22. The filling nozzle according to claim 16, further comprising a movable member (4) adapted for selectively opening the claws, said opening member (4) being movable between a working position preventing movement of the claws (2) from the open position to the closed position and an idle position enabling the movement of the claws (2) from the open position to the closed position.

23. The filling nozzle as claimed in claim 22, wherein the opening member (4) is pushed by default towards the working position thereof by a return member (5).

24. The filling nozzle as claimed in claim 22, wherein the opening member (4) opens into the central space located between the at least one claw (2) and the longitudinal axis (A), and wherein the opening member (4) is movable from the working position thereof to the idle position thereof under the direct or indirect mechanical action of the filling connector (1) when the filling connector (1) penetrates the central space of the filling nozzle.

25. The filling nozzle according to claim 16, further comprising at least one claw (2) movable between the open and closed positions via a bending and/or pivoting movement about an axis (20) of articulation fixed in relation to the base (15, 16) wherein the axis (20) of articulation is located at an extremity of the claw (2) that corresponds to an upstream side of the nozzle in a direction of intended flow of a filling gas in the filling nozzle.

26. The filling nozzle according to claim 16 comprising three or four claws (2) arranged about the longitudinal axis (A).

27. A filling unit comprising a filling connector (1) and a filling nozzle, wherein
a) the filling nozzle is designed to engage with a filling connector (1) of a faucet of a pressurized-fluid recipient, including a base (15, 16) and at least one claw (2) extending longitudinally about a longitudinal axis (A), the central space located between the claw or claws (2) and the longitudinal axis (A) forming an enclosure intended to receive a filling connector (1) of cylindrical overall shape, the internal face of the at least one claw (2) located facing the central space being of flat overall shape and having reliefs (12) and/or recesses (22) of set dimensions, the reliefs (12) and/or recesses (22) being spaced relative to one another in a set fashion so that they fit into the matching grooves (11) and/or reliefs (21) formed on the external face of a filling connector (1), the at least one claw (2) being movable in relation to the base (15, 16) transversely in relation to the longitudinal axis (A) between an open position to enable the insertion of the filling connector (1) in the central space and a closed position to enable the internal face of the claws (2) to fit the external face of the filling connector (1), said nozzle further including a locking member (3) movable in relation to the base (15, 16) and in relation to the at least one claw (2) between an active position locking the claws (2) in closed position and an inactive position enabling the claws (2) to move to the open position, the filling nozzle further characterized in that the locking member (3) is adapted to be pushed by default towards the active position thereof by a return member (60), and in that the filling nozzle includes a valve actuator (111) that is selectively movable in the central space to actuate the opening of at least one internal valve of a filling connector (1), the valve actuator (111) of the filling nozzle being movable in translation independently of the position of the at least one claw (2) and of the position of the locking member (3) ;and wherein
b) the filling connector (1) comprises a body of cylindrical overall shape extending along a longitudinal axis, the external surface of which has transversal grooves (11) and/or reliefs (21) of set dimensions oriented perpendicular to the longitudinal axis of the filling connector (1), the grooves and/or reliefs (21) being spaced in a set manner in the longitudinal direction of the filling connector (1), and the reliefs (12) and/or recesses (22) of the at least one claw (2) match said grooves and/or reliefs (21) of the filling connector (1) to enable a selective engagement of the claws (2) to the body of the connector (1).

28. The unit as claimed in claim 27, wherein at least some of the transversal grooves (11) and/or reliefs (21) are formed on the circumference of the body of the filling connector (1) to enable an engagement of the at least one claw (2) to the body of the connector (1) regardless of an angular position of the at least one claw (2) about the longitudinal axis (A) of the filling connector (1).

29. A method for filling a recipient (13) with pressurized fluid comprising a faucet (112) with a filling connector (1) provided with a body of cylindrical overall shape extending along a longitudinal axis, the external surface of which includes transversal grooves (11) and/or reliefs (21) of set dimensions oriented perpendicular to the longitudinal axis of the connector (1), the filling connector (1) including at least one internal valve (7, 10), characterized in that the method includes a step in which the filling connector (1) is mechanically connected to a filling nozzle designed to engage with a filling connector (1) of a faucet of a pressurized-fluid recipient, including a base (15, 16) and at least one claw (2) extending longitudinally about a longitudinal axis (A), the central space located between the claw or claws (2) and the longitudinal axis (A) forming an enclosure intended to receive a filling connector (1) of cylindrical overall shape, the internal face of the at least one claw (2) located facing the central space being of flat overall shape and having reliefs (12) and/or recesses (22) of set dimensions, the reliefs (12) and/or recesses (22) being spaced relative to one another in a set fashion so that they fit into the matching grooves (11) and/or reliefs (21) formed on the external face of a filling connector (1), the at least one claw (2) being movable in relation to the base (15, 16) transversely in relation to the longitudinal axis (A) between an open position to enable the insertion of the filling connector (1) in the central space and a closed position to enable the internal face of the claws (2) to fit the external face of the filling connector (1), said nozzle further including a locking member (3) movable in relation to the base (15, 16) and in relation to the at least one claw (2) between an active position locking the claws (2) in closed position and an inactive position enabling the claws (2) to move to the open position, the filling nozzle further characterized in that the locking member (3) is adapted to be pushed by default towards the active position thereof by a return member (60), and in that the filling nozzle includes a valve actuator (111) that is selectively movable in the central space to actuate the opening of at least one internal valve of a filling connector (1), the valve actuator (111) of the filling nozzle being movable in translation independently of the position of the at least one claw (2) and of the position of the locking member (3), and wherein the internal face of the at least one claw (2) of the filling nozzle complementarily engages the external shape of the connector (1) during the step of mechanically connecting the filling connector (1) to the filling nozzle.
